(19) United States
(12) Patent Application Publication
(10) Pub. No.: US 2008/0314886 A1
(43) Pub. Date: Dec. 25, 2008

(54) CTEW process

(76) Inventor: Madhav A. Unde, Sacramento, CA (US)

Correspondence Address: Madhav A. Unde, 1980 Watt Avenue, Sacramento, CA, 95825, US

(21) Appl. No.: 11/812,388

(22) Filed: Jun. 19, 2007

(51) Int. Cl. B23K 31/00

(52) U.S. Cl. 219/137 R

(57) ABSTRACT

In CTEW process, U.S. Pat. No. 6,127,643, a process of reducing the residual stress during welding process is described. In this process a material is deposited at the Trailing Edge of Weld (TEW) that absorbs the heat from the solidifying weld metal. This causes the directional solidification effect in the solidifying metal and reduces the heat entering into base metals. In effect microstructure is normalized, and heat affected zone in base metals is reduced. Improvements in the process are made by determining the volume of the solidifying metal, its heat content, and heat transfer area to base metals of the weld. The ratio of heat absorbed at the TEW to heat input to weld is a constant in a specific weld, determining the improvements.

The CTEW process described in U.S. Pat. No. 6,127,643 presents the process of reducing the weld defects in a fusion weld during welding by depositing a material on the Trailing Edge of Weld (TEW). The chemistry and physical properties of the material selected for deposition at the TEW are determined earlier.

In weld solidification exposed crystal faces on solid surface interface with solidifying metal. Such crystal faces are randomly aligned. Growth of crystals in liquid metal takes place from these exposed crystal faces. As a natural phenomenon growth of a crystal in liquid is in a direction opposite to the instantly established cooling gradient. The energy for the growth is dependent on the strength of the cooling gradient. Because of numerous neighboring crystals and their numerous faces aligned at random, growth pattern of crystals in liquid metal is also random. Such pattern provides opportunity for the capture of gas molecules that cause undesired gas inclusion defects. A gas molecule may be absorbed or generated during the solidification process. Therefore there may be gas porosity or gas pockets formed in the solidified weld. Such pattern may also cause other defects depending upon the cooling speed. These may include un-uniform branching, crossing of branches as well as structures wrapping around growing crystals. Where cooling effects are fast, stresses may generate micro-cracks during solidification process. After solidification, in a jungle of microstructure, the microstructure retains the residual stress, and every defect generated may never be removed later after weld solidification. Further if we take a cross-section of a solidified weld at right angles to the weld length, such a plane may have un-uniform residual stress distribution. Overall value of the residual stress as set in can be determined by SGB method. (U.S. Pat. No. 4,386,727.)

Welding is a quasi-stationary operation, since base plates are stationary and heat source is moving. In a steady welding condition on a thickness of base plates welded, physical dimensions of hill of heat, the volume of the solidifying metal, heat content of the solidifying metal and the surface area of the interface transferring heat to base plates on both sides are dynamic constants. Second order Quai-stationary States (SQS) include the Liquid Metal Zone (LMZ), Solidifying Metal Zone (SMZ) and the Solid State at High Temperature (SSHT) zone. In this steady state liquid metal volume extends up to a point on the surface of the weld plates where it is yet liquid.

Heat input adds superheat to the molten liquid metal. A desired function of the superheat input to a weld is to melt solid surface at the interface of liquid metal. Available crystallographic faces of the micro structure at the solid interface join with those forming in liquid metal as the temperature of the SQS system falls.

The improvements of determining the necessary heat sink at the TEW in CTEW process can be made. The three dimensional solidifying volume can be determined by considering geometrical/thermal profile of the weld. In a specific case, where the shape of cup of molten metal, in cross section at right angles direction of welding, is half circle, the solidifying volume of the cone with a diameter equal to twice the penetration at the base is half the volume of the cone. The diameter of such a cone is along the center line of the heat input. This centerline is the centerline of the LMZ. The apex of such a cone is at a point where the last liquid metal is yet to be solidified; the height of the cone can be measured on the surface of the weld. Trajectories in LMZ may generate different shapes of the cup of the cup of molten metal. Such a shape and volume generated may be determined experimentally by taking cross-section of a solidified weld, or by computer application. The train of SQS states progresses at a constant welding speed, “s”.

In the improved process heat content of the material necessary for deposition at the TEW can be determined. It causes the directional cooling effect in the solidifying metal. The directional cooling effect provides stronger energy for growth of a micro-structure, in the direction of cooling, in three dimensional SMZ volume. This component of energy aligns the micro-structure in the directional of cooling gradient established by the heat sink generated at the TEW. Any crystal growing in the SMZ is also acted on by another cooling gradient from the solid base metal interface, transferring heat to base metals on both sides of the weld joint.

Another effect of the deposition of material at TEW is it provides a means for reducing heat dissipated in base metals thru the interface. Proportion of heat absorbed at the TEW to heat content of the solidifying metal volume can be determined. Reduction of heat dissipated into base metals reduces a component of energy that contributes to growth of each crystal in the solidifying liquid metal. Therefore a crystal grown in the SMZ will be aligned more in the direction of directional solidification. Proportion of heat absorbed at TEW to heat transferred to base metals on both sides can also be determined. As dissipation of heat into base metals is reduced, heat affected zone (HAZ) in base metals is reduced. HAZ starts from the point in base metals below the maximum penetration. Physical alignment of (solidified) mica-structure due to directional solidification, in effect places overall micro-structure in a condition that is normalized. This is due to two reasons; first is abnormalities in misalignment are reduced and displacements of gas molecules eliminate defects due to gas inclusions. These effects reduce the residual stress.

### SUMMARY OF MY INVENTION

It is therefore the principal object of improvement to determine the dynamic heat sink necessary at the TEW to ensure defect free microstructure in a welded joint.

Further object of the improvement is to determine ratio of heat absorbed by the heat sink at TEW to heat input to weld. This constant of proportionality, defined here as, k1, determines the reduction of the residual stress; it takes into account the efficiency of heat transfer from the arc or heat source to molten base metals and equals H3/H1 where H3 is the heat absorbed at TEW by the deposited material in CTEW process and H1 is the Heat Input to the weld. Further object of the improvement is to determine a ratio k2 of heat absorbed at the TEW H3 to heat transferred to base metals H2; this constant equals H3/H2 determines the limit of heat that may be permitted to transfer to base metals on both sides, such quantity of transferred heat H2, not affecting the physical properties of base metals welded that may cause damage to base metals.

Further object of improvement is to eliminate trial-and-error methods in this IPSR (In Process Stress Relief) method to ensure development of microstructure without defect/s.

Still further objects and salient features of the innovation will be apparent from the following detailed description of the experiment and claims when considered with annexed drawings which includes several preferred embodiments of the present innovation.

### BRIEF DESCRIPTION OF THE DRAWINGS

FIG. 1 shows the cross section of the weld at right angles to direction of welding in a process not using CTEW technique. The said figure shows the centerline of heat input to weld along ‘ac’, the depth of penetration. H1 is the heat input to weld. Arrow attached to the centerline shows direction of welding towards the left. Profile “abcda” is the cross section of the volume of the liquid and solidifying molten metal. Geometrical parameters of the profile “abcda” can be determined. Total profile of the weld is in SQS states and moves at a constant welding speed “s” towards left.

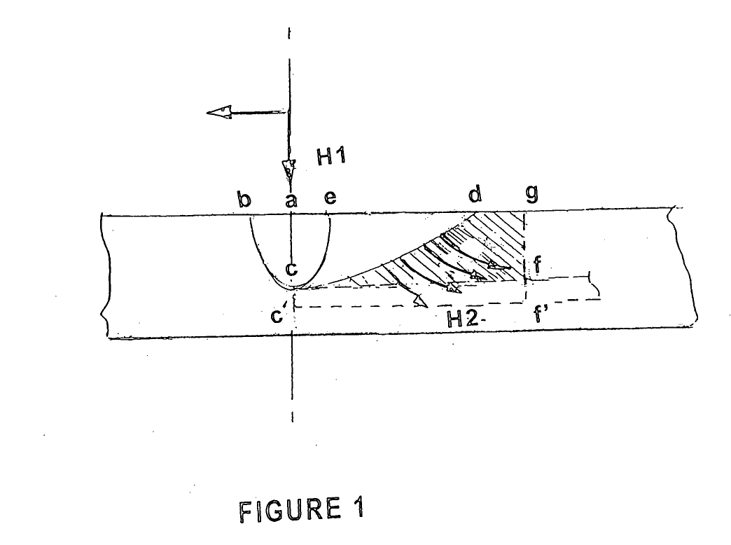

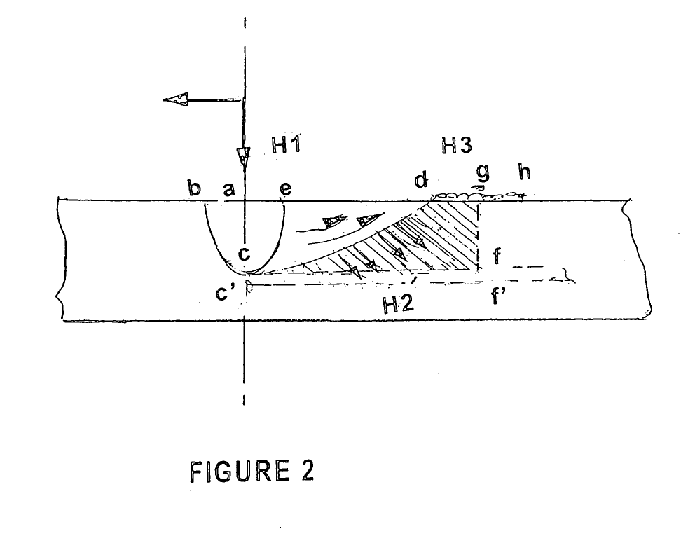

The FIG. 1 also shows the heat absorbed by base metals on both sides, as H2. HAZ created extends towards right. This zone extends laterally up to top surfaces of both plates wrapping around the solidifying weld nugget. “bce” is the LMZ. Heat transfers from “bce” to solidifying metal “ecd”; Arrows attached to “cd” in the cross section show heat transfer from the solidifying volume “ecd” to base metals; “cc′f′f” is the limit beyond which heat effects in base metals may not occur. The figure shows cross-section “cfgd” which is solid state at high temperature the SSHT zone; There is no heat sink at TEW in this welding operation. Therefore all heat content of the solidifying metal transfers to base metals, as H2.

The overall residual stress that may be responsible for bending can be measured using SGB method. (U.S. Pat. No. 4,386,727.)

FIG. 2 shows cross section of the CTEW weld with heat sink at TEW by deposited material in the process, using the same heat input H1 at the same welding speed, ‘s’, using the same thickness of base materials. Deposited material melts due to absorption of heat from the solidifying volume ‘ecd’. This layer is shown as “dg”. Section behind “dg” towards right shows a layer of coating after the melted material becomes solid. The directional solidification caused by the dynamic heat sink at TEW is shown by arrows inside the section “ecd”. Arrows attached to “cd” of the three dimensional solidifying volume, in FIG. 2, “ecd” show heat transfer to base metals. These arrows are shown smaller the corresponding arrows shown in FIG. 1, because heat absorbed by deposited material layer ‘dg’ reduces the heat entering into base metals on both sides. In effect HAZ is reduced and is shown by “cc′f′f”. This is shown smaller than the HAZ shown in FIG. 1.

In FIG. 2, heat absorbed by base metals is shown as H2′. Heat absorbed by heat sink in this figure is H3 and it generates molten that solidifies extending towards right and provides a solidified cover over the microstructure still in hot condition beneath it; it prevents radiation of heat to atmosphere. This extended cover therefore incubates the microstructure beneath it. Heat inputs in FIG. 1 and FIG. 2 are the same, H1; and as base materials and their thicknesses welded are the same; further the penetration ‘ac’ as well as shapes “bc” and “cd” shown in cross-sections in both figures are the same, and are generated by of the cup of molten metal, “bce” that is cross-section of LMZ; part of heat is transferred that generates the HAZ, a part is absorbed by heat sinks which may be fixtures and then lost by radiation to atmosphere; some heat is transferred to base metals a head of the molten cup, LMZ. In an application the heat losses mentioned will be constant. In general, lower the welding speed higher will be these losses.

### DETAILED DESCRIPTION OF THE PREFERRED EMBODIMENTS

Experiments were made on ½ inch thick steel plates welded in butt joint, using GMAW (Gas Metal Arc Welding) process. In each case heat input was 40 KJ/Inch. Welding speed was 8 inches per minute at 20 Volts.

With reference to FIG. 1 and FIG. 2, metal volume “acd” was calculated. It was 0.07 cubic inch. The surface area of the interface “cd” permitting the heat to transfer to base plates either side was calculated. It was 3.28 square inches, approximately.

Referring FIG. 2, the residual stress was measured. It was found reduced by 9000 psi (pounds/sq. inch), the factor K2 ratio H3/H2′ was 9%. Heat that would enter base metals is reduced because of H3 absorbed at TEW. This H3 quantity of heat is reduced from (total) heat input to weld H1. The ratio k1, H3/H1 approximated k2. Reduction of heat by 9% entering into base metals was found to reduce the residual stress by 16% of the tensile strength of steel, compared with welding without CTEW process, shown in FIG. 1. Reduction in the residual stress was effect of normalization of microstructure due to directional solidification in the solidifying metal volume, incubation of microstructure beneath the solidified layer of deposited material at TEW and displacement of gas molecules that would otherwise be captured by the microstructure.

It is to be understood that while detailed drawings and example describe the preferred embodiment of my invention, they are only for illustration. The Illustrations described are for proving the effects of improvement only; and in practical application, heat sink material, materials of base plates or heat input and fusion welding process used itself or back-up or other fixture details are unimportant.

My invention s defined by the following claims:

1. (a) Determining the volume of molten solidifying metal from geometry or thermal profile the fusion weld of base metals joined y said welding;
(b) Determining the heat content of the said volume in the said fusion weld;

2. Determining the proportion of the heat absorbed by the heat sink caused by the deposited material at the trailing edge of weld to heat content of the said solidifying volume metal refereed in claim 1(a);

3. The process as claimed in above claims that extracts heat into the deposited material at the trailing edge of weld, eliminating the said quantity from entering into base materials on lateral sides;

4. The process as claimed in above clams, permitting determination of the heat sink necessary at the said trailing edge of the said weld that forms the improved micro-structure by causing directional solidification in the said solidifying volume referred in claim 1(a);

5. The process as claimed in above claims in which the solidified layer of material deposited at the said trailing edge of weld prevents heat loss due to radiation to atmosphere and incubates the micro-structure beneath it;

6. The process as claimed in above claims, that reduces the residual stress in the said solidified micro-structure of the said weld and the heat affected zone in the same base metals.
